(19) United States
(12) Patent Application Publication
(10) Pub. No.: US 2006/0187656 A1
(43) Pub. Date: Aug. 24, 2006

(54) Solar spotlight

(76) Inventors: Gustav P. Kuelbs, Grapevine, TX (US); Mingqiang Pu, Xinhua Town (CN)

Correspondence Address: WORLD FACTORY, INC.;c/o LAW OFFICES OF JAMES E. WALTON, P.L.L.C., 1169 N. BURLESON BLVD., SUITE 107-328, BURLESON, TX, 76028, US

(21) Appl. No.: 11/187,286

(22) Filed: Jul. 22, 2005

Related U.S. Application Data
(60) Provisional application No. 60/655,988, filed on Feb. 24, 2005.

(51) Int. Cl. F21L 4/00; F21L 13/00

(52) U.S. Cl. 362/183

(57) ABSTRACT

A solar light has a main housing, a solar housing, and a light housing. The solar housing and the light housing are each coupled to and independently adjustable relative to the main housing to provide increased flexibility in placement, orientation, and configuration of the light. A support member on the main housing is designed for connection to stakes, risers, surface mounts, and other mounting means, to provide further increased flexibility in use of the light.

This application claims the benefit of U.S. Provisional Application No. 60/655,988, filed 24 Feb. 2005, titled “Solar Spotlight.”

### BACKGROUND OF THE INVENTION

1. Field of the Invention

The present invention relates to outdoor lighting, and more particularly, to outdoor solar landscape lighting.

2. Description of Related Art

Solar landscape lights are well known in the art, but have several limitations. Many of these limitations result in aesthetic problems, while others limit the application of a particular light to limited areas of a landscape. For example, often the solar collector cannot be adequately adjusted and/or positioned to optimize the collection of solar energy. In addition, the lighting elements have little or no adjustment capabilities.

Although great strides have been made in the are of solar lighting, many shortcomings remain.

### SUMMARY OF THE INVENTION

There is a need for a solar light in which the solar collector and at least one lighting element are both independently adjustable.

Therefore, it is an object of the present invention to provide a solar light in which the solar collector and at least one lighting element are both independently adjustable.

This object is achieved by providing a solar light having a main housing, a solar housing having at least one solar collector, and at least one light housing. The solar housing and the light housing are each adjustably attached to the main housing to provide increased flexibility in placement and positioning of the solar collector and the light. A support member on the main housing is adapted for quick and easy connection to a stake, a riser, and/or a surface mount, to provide further increased flexibility in placement of the light.

The present invention provides significant benefits and advantages, including: (1) the solar collector can be adjusted independent of the light housing so as to optimize solar energy collection; (2) the position and orientation of lighting elements can be independently adjusted, thereby allowing more areas to be illuminated by a single light unit; (3) the light can be configured in a low-profile design, thereby reducing the obtrusiveness of the light; and (4) the light housing is adapted to be connected to stakes, risers, surface mounts, and other mounting means.

### BRIEF DESCRIPTION OF THE DRAWINGS

The novel features believed to be characteristic of the invention are set forth in the appended claims. However, the invention itself, as well as a preferred mode of use and further objectives and advantages thereof, will best be understood by reference to the following detailed description when read in conjunction with the accompanying drawings, wherein:

FIG. 1 is a perspective view of a solar spotlight;

FIG. 2 is a perspective view of the bottom of a solar spotlight;

FIG. 3 is a schematic of a solar energy system;

FIG. 4 is a partially exploded perspective view of a solar spotlight;

FIG. 5 is perspective view of a solar spotlight attached to a riser attached to a stake;

FIG. 6 is a perspective view of a solar spotlight attached to a surface mount;

FIG. 7 is a partially exploded view of a solar spotlight, riser, and stake;

FIG. 8 is a partially exploded view of a solar spotlight and a surface mount;

FIG. 9 is a side view of a solar spotlight attached to a riser attached to a stake;

FIG. 10 is a frontal view of a solar spotlight attached to a riser attached to a stake;

FIG. 11 is a frontal view of a solar spotlight attached to a surface mount; and

FIG. 12 is side view of a solar spotlight attached to a surface mount.

### DETAILED DESCRIPTION OF THE PREFERRED EMBODIMENT

The present invention represents the discovery that a highly flexible solar spotlight can solve many lighting problems with a single light unit.

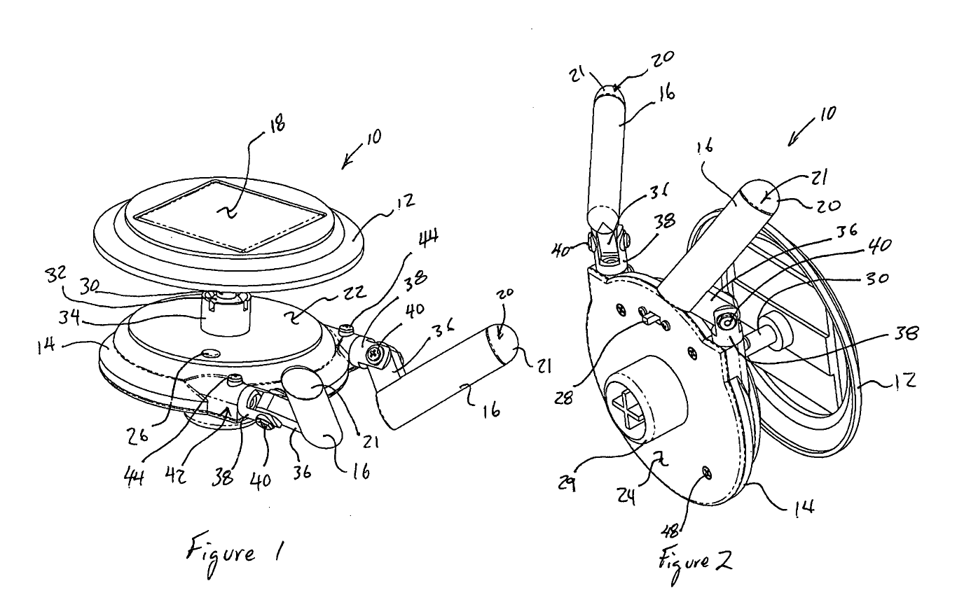

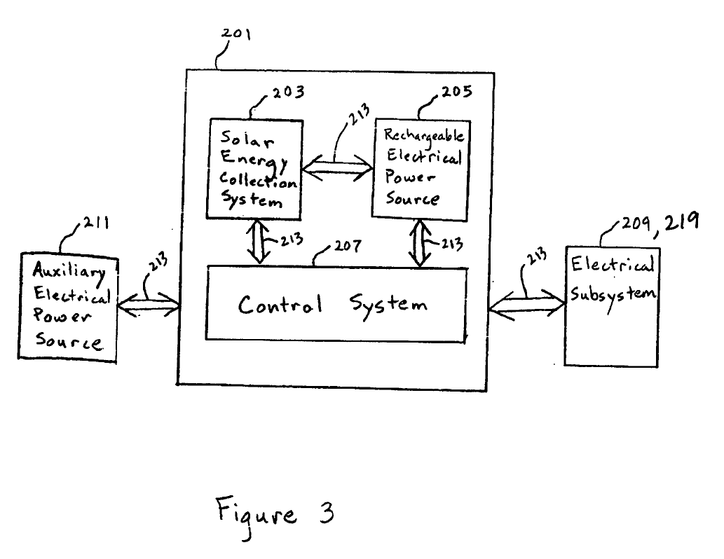

Referring to FIGS. 1 and 2 of the drawings, a solar spotlight 10 has a solar housing 12, main housing 14, and light housings 16. Light housings 16 and solar housing 12 are coupled to main housing 14. Solar housing 12 carries a solar panel 18 that is photo voltaic, as is described in more detail below. Light housings 16 each carry at least one light element 20 that emits light upon the application of electrical energy, as described in more detail below. Light elements 20 are preferably light emitting diodes (LED's), but may be organic light emitting diodes, incandescent bulbs, cold cathode ray tubes, fluorescent lights, or any other suitable electrical lighting apparatus, or combination thereof. Main housing 14 has an upper surface 22 and a lower surface 24.

Main housing 14 preferably carries a photo resistor, or photo cell 26, on upper surface 22 and a switch 28 on lower surface 24. Photo cell 26 ensures that light elements 20 are only lit during low light situation. Switch 28 allows the selection of a lighting mode, such as HIGH-OFF-LOW, or other modes described in more detail below. The position of photo cell 26 may depend on the sensitivity of photo cell 26, but is generally on a exposed surface, such as upper surface 22, or on solar housing 12. Switch 28 may be placed based on aesthetic and wiring considerations, as is apparent by placement on lower surface 24 in the embodiment shown. Other locations for switch 28 may include upper surface 22, other surfaces of main housing 14, solar housing 12, or remote. it will be appreciated that solar spotlight 10 may be operated remotely by a wireless control system. Main housing 14 also includes a support member 29 on lower surface 24, as is discussed in more detail below.

Solar housing 12 is preferably mounted to main housing 14 via a universal joint to provide maximum adjustability to optimize solar exposure for panel 18 depending on the location of spotlight 10. For example, if spotlight 10 is near a bush or other obstacle, solar housing 12 may be tilted away from the obstacle, toward an open area. In addition, solar housing 12 may be oriented to optimize the collection of solar energy throughout daylight hours. In the embodiment shown, solar housing 12 has a shaft 30 extending opposite panel 18. The distal end of shaft 30 is a ball 32. Upper surface 22 of main housing 14 has a cup 34 adapted to receive ball 32 snuggly. This ball and socket universal joint configuration allows solar housing 12 to be oriented in a wide variety of positions. It is preferred that the universal joint be sufficiently snug to hold solar housing 12 in the selected orientation without the need for additional fasteners. Other hinge combinations known in the art may be used to connect solar housing 12 to main housing 14.

Continuing with FIGS. 1 and 2, light housings 16 are preferably elongated members with elliptical cross-sectional areas. Light housings 16 may have a wide variety of cross-sectional areas, including round and various polygonal shapes. The elongated nature of light housings 16 helps a user position light housings 16 relative to main housing 14, so as to aim the pattern of light from light elements 20 in selected areas. More importantly, light housings 16 are hingedly attached to main housing 14 to provide a wide range of positions. In the embodiment shown, light housings 16 have a hinge leg 36. Leg 36 is received in support arm 38 and hingedly attached to support arm 38 by hinge screw 40. Main housing 14 has a receptacle 42 adapted to rotably receive support arm 38. Additionally, a setscrew 44 is operably connected with receptacle 42 to adjust the force needed to rotate support arm 38. Likewise, hinge screw 40 may be tightened or loosened to adjust the force needed to move light housing 16 relative to support arm 38. By loosening both hinge screw 40 and setscrew 44 light housing may be freely moved to a very wide variety of positions through the combination of rotation and hinged motion. Once light housing 16 is in a desired position, hinge screw 40 and setscrew 44 may be tightened to hold light housing in the desired position. It will be appreciated that light housings 16 may also be held in position by a press fit universal joint similar to the universal joint used between solar housing 12 and main housing 14.

Light housings 16 support lenses 21. Lenses 21 are preferably poly-acrylic domes that focus the light emitted form light elements 20 within light housings 16 to a materials may be used for lenses 21 to provide differing patterns of light dispersion.

Now referring to FIG. 3, the preferred embodiment of solar energy system 201 according to the present invention is illustrated. Solar energy system 201 preferably comprises a solar energy collection system 203, a rechargeable electrical power source 205, and a control system 207. Solar energy system 201 is preferably conductively coupled to an electrical subsystem 209, including light elements 20. Solar energy system 201 may optionally be conductively coupled to an auxiliary electrical power source 211. Conductive coupling is preferably achieved through the use of electrical conductors 213 such as insulated copper wires, circuit boards, or other suitable devices or means for conductively coupling electrical components together.

Solar energy collection system 203 preferably comprises a solar collector 215 and other necessary circuitry for receiving and collecting solar energy, and converting the solar energy into electrical energy. Solar energy collection system 203 is preferably conductively coupled to both rechargeable electrical power source 205 and control system 207 with electrical conductors 213. Rechargeable electrical power source 205 preferably comprises a rechargeable battery 217 for storing electrical energy; however, rechargeable electrical power source 205 may alternatively comprise any rechargeable electrical power storage device, such as a capacitor, battery pack, any other suitable device for storing electrical energy, or combinations thereof. Rechargeable electrical power source 205 is preferably conductively coupled to solar energy collection system 203 and control system 207 with electrical conductors 213.

Solar energy system 201 converts solar energy into electrical energy and supplies that electrical energy to one or more electrical subsystems 209. Solar energy collection system 203 preferably delivers electrical energy to rechargeable electrical power source 205 to provide a trickle charge to rechargeable electrical power source 205. However, when rechargeable electrical power source 205 is fully charged, solar energy collection system 203 preferably delivers electrical energy to control system 207 where the electrical energy is preferably diverted for uses other than charging rechargeable electrical power source 205. For example, the electrical energy could be used to directly power electrical subsystem 209, rather than electrical subsystem 209 consuming power from rechargeable electrical power source 205.

An optional auxiliary electrical power source 211 preferably comprises an alternating current power source, such as a conventional AC outlet; however, auxiliary electrical power source 211 may alternatively comprise a direct current power source, such as a non-rechargeable battery; one or more fuel cells; a renewable energy source, such as a wind-powered generator; a rechargeable battery pack, in which the battery pack is removed, recharged remotely, and thereafter replaced back into auxiliary electrical power source 211; or any other electrical power source suitable for providing solar energy system 201 with additional electrical energy. Of course, the foregoing configuration allows for the interchanging, or swapping, of battery packs. Auxiliary electrical power source 211 is preferably conductively coupled to solar energy system 201 and preferably delivers electrical energy to control system 207. Auxiliary electrical power source 211 preferably supplies electrical energy for a variety of uses including: powering electrical subsystems 209, recharging rechargeable electrical power source 205, and powering other solar energy system 201 circuitry such as control system 207.

Alternative embodiments of solar energy system 201 may not include solar energy collection system 203. Instead, solar energy system 201 may comprise a circuit for powering electrical subsystem 209 operable only by electrical energy supplied by auxiliary electrical power source 211.

Control system 207 preferably comprises circuitry, microprocessors, memory devices, sensors, switches, and other electronic components necessary to: partially or fully direct electrical energy from solar energy collection system 203 to rechargeable electrical power source 205, fully or partially direct electrical energy from solar energy collection system 203 to electrical subsystems 209, allow a user to manually switch solar energy system 201 on, off, and between several modes of operation, receive input to alter or control the performance of the recharging of rechargeable electrical power source 205 and/or the supply of electrical energy to electrical subsystems 209, control the performance of electrical subsystems 209, fully or partially charge rechargeable electrical power source 205 with electrical energy supplied by auxiliary electrical power source 211, and fully or partially power electrical subsystem 209 with electrical energy from auxiliary power source 211.

It should be appreciated that while solar energy system 201 comprises control system 207 in this preferred embodiment, simpler and less sophisticated embodiments of solar energy system 201 are possible. For example, solar energy system 201 may not comprise control system 207, but merely comprise solar energy collection system 203 and rechargeable electrical power source 205 conductively coupled to each other with electrical conductors 213.

Electrical subsystem 209 is preferably a lighting subsystem 219 for providing illumination. Lighting subsystem 219 preferably comprises light elements 20 conductively coupled to solar energy system 201. It will be appreciated that electrical subsystem 209 may be a water pumping subsystem, sound subsystem, video subsystem, microphone subsystem, receiving and transmitting subsystem, motion actuating subsystem, cooling subsystem, heating subsystem, raising and lowering subsystem, water agitation subsystem, electrical motor subsystem, any other electrically powered subsystem, or combination thereof.

A translucent shield, a lens, reflector, seal, light fixture, or a combination of these may optionally be attached to or operably associated with lighting subsystem 219 to enhance or alter the illumination provided by light elements 20. These optional shields, lenses, reflectors, seals, and fixtures may also be configured to prevent water, dirt, or other particulate matter from interfering with the operation of light elements 20. Further, it should be appreciated that these optional shields, lenses, reflectors, seals, and fixtures may be incorporated into any embodiment of the present invention.

It should be appreciated that lighting subsystem 219 and control system 207 may include selected components, switches, circuitry, microprocessors, and memory chips to produce a variety of optional features. For example, optional features may include: manual lighting intensity controls, blinking lights, fading lights, changing the light color, motion activated lighting, sound activated lighting, a wide variety of lighting sequence or motion effects, and any other desired lighting effects or interactive means for controlling lighting effects. Of course, any components, circuitry, microprocessor control chips, or other means of controlling or altering the functionality of electrical subsystem 209 may be conductively coupled to solar energy system 201, electrical subsystem 209, and/or auxiliary electrical power source 211. Further, where electrical subsystem 209 is not a lighting subsystem 219, it should be appreciated that similar controls, programming capabilities, interactive input devices, and other performance controls or alteration means may be incorporated into electrical subsystem 209 and/or control system 207.

For those embodiments having photo cell 26, it is preferred that photo cell 26 operate in conjunction with control system 207. Photo cell 26 detects the presence of light and controls whether light elements 20 are switched on or off. For example, when photo cell 26 detects a substantial amount of light, light elements 20 are switched off and provide no illumination. However, when photo cell 26 detects a low level of light, light elements 20 are switched on and provide illumination. Alternatively, photo cell 26 may be used to dim or brighten the output of light elements 20. In addition, one or more on-off switches or buttons may be operated in conjunction with control system 207 to facilitate the operation of solar energy system 201, or to vary the operation and control of solar energy system 201, auxiliary electrical power source 211, or electrical subsystems 209. It will be appreciated that the operation of solar energy system 201, auxiliary electrical power source 211, and electrical subsystems 209 may be controlled remotely by infrared light, radio wave, or other types of wired or wireless transmitters and receivers.

It should be appreciated that solar energy system 201 may further comprise or be conductively coupled to one or more connection ports for conveniently interfacing solar energy system 201 with other components, systems, subsystems, or any other suitable devices. These connection ports are preferably conductively coupled to control system 207; however, these connection ports may alternatively be conductively coupled to any other component of solar energy system 201, auxiliary electrical power source 211, or electrical subsystems 209. It should be understood that the components of solar energy system 201, auxiliary electrical power source 211, and electrical subsystem 209 are preferably substantially protected such that water, dirt, and other matter is prevented from interfering with the operation of solar energy system 201, auxiliary electrical power source 211, and electrical subsystem 209.

Components of solar energy system 201, auxiliary electrical power source 211, and electrical subsystems 209 may be located substantially near each other, or may be separated from each other. It will be appreciated that in alternative embodiments, components of solar energy system 201, auxiliary electrical power source 211, and electrical subsystem 209 may be located substantial distances from each other while remaining conductively coupled. For example, an alternative embodiment of the present invention may be configured such that solar collector 215 is located on a rooftop and is conductively coupled to rechargeable electrical power source 205, other components, systems, and/or subsystems which are located a significant distance away from solar collector 215, such as near ground level.

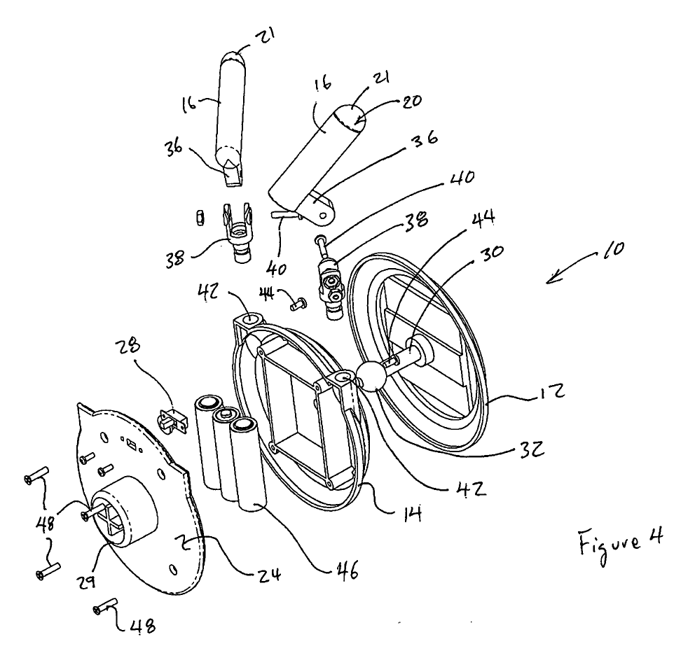

Referring now to FIG. 4 of the drawings, an exploded view of spotlight 10 allows for a better understanding of the construction and assembly of spotlight 10. All of the elements described in reference to FIGS. 1 and 2 are shown, and some elements hidden or partially hidden by the views in FIGS. 1 and 2 are shown more clearly. Ball 32 is shown more clearly as removed from cup 34. Support arm 38 is shown in more detail as removed form receptacle 42. Hinge screw 40 is shown removed form support arm 38 and leg 36, allowing a better appreciation of their individual design in this embodiment. Additionally, batteries 46 are shown removed from main housing 14. Batteries 46 are used in this embodiment as a rechargeable electrical power source 205. Main housing 14 is secured by screws 48 in this embodiment, but may be secured by adhesive, snaps, or other securing means, both releasable and non-releasable.

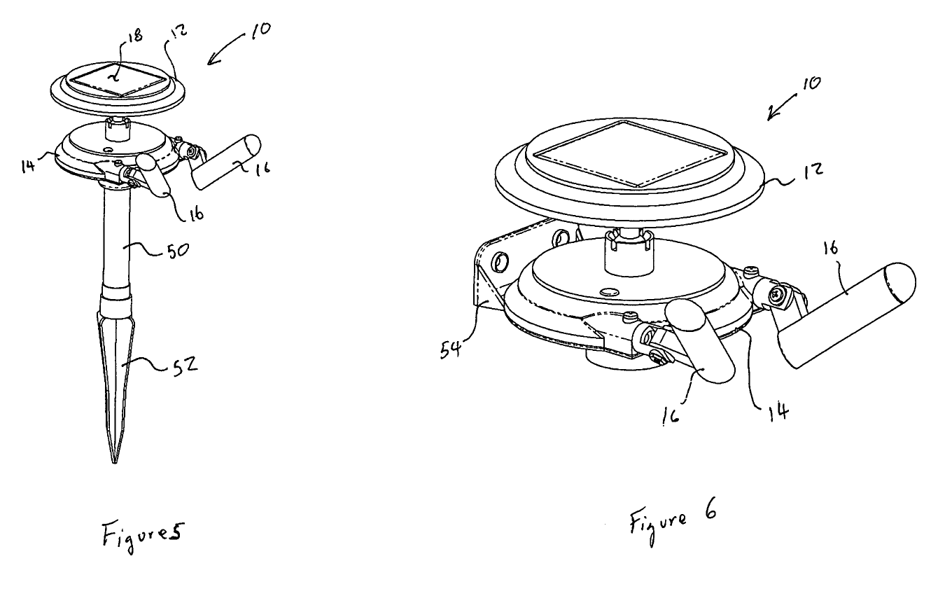

Referring now to FIG. 5 of the drawings, spotlight 10 is shown attached to riser 50 that is attached to stake 52. Stake 52 is adapted for secured insertion in soil. Riser 50 is adapted to attach to an upper end of stake 52 and to support member 29 of spotlight 10 to raise spotlight 10 above the soil. Stake 52 is adapted for direct mounting of spotlight 10 in situations where spotlight 10 is to be positioned near soil, as is discussed in more detail below. Riser 50 may be a telescoping riser for which the length may be adjusted by extending one portion relative to another. The length of riser 50 may also be adjustable by a screw-type adjustment means. Adjustable risers 50 allow the vertical position of solar light 10 to be adjusted. This is particularly useful in applications in which the height or size of objects near solar light 10 changes over time, such as with plants, bushes, and shrubs.

Referring now to FIG. 6 of the drawings, spotlight 10 may include a surface mount 54. Surface mount 54 is adapted for connection to support member 29 and attachment to a surface, such as a fence, wall, timber, or other surface, as is discussed in more detail below.

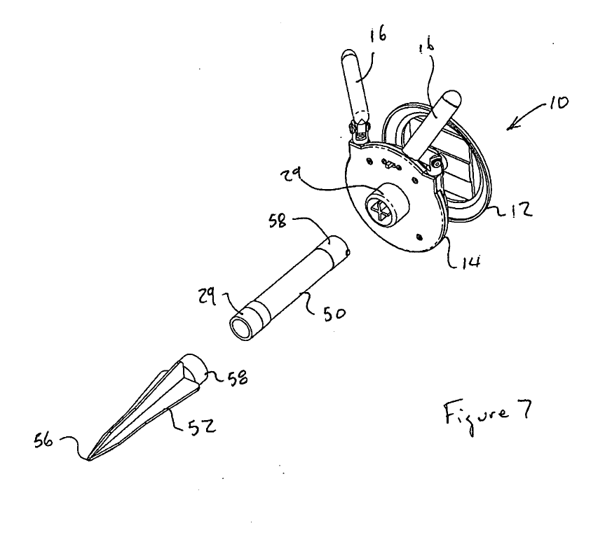

Referring now to FIG. 7 of the drawings, spotlight 10, riser 50, and stake 52 are shown detached. As can be seen from this view, stake 52 has a pointed end 56 adapted for insertion into the ground and a mounting portion 58 adapted for direct mounting to support member 29 of spotlight 10 or riser 50. Riser 50 has a support end 60, similar to support member 29, and a mounting portion 58 adapted for direct mounting to support member of spotlight 10 or an additional riser 50. This configuration of stake 52 and riser 50 allows for a wide variety of placements of spotlight 10, ranging from ground level when stake 52 is fully inserted and spotlight 10 is directly mounted thereon, to slightly above ground level when stake 52 is not fully inserted and spotlight 10 is mounted directly thereon, to a riser interval above the soil when stake 52 is fully inserted and a riser 50 is mounted thereon and spotlight 10 is mounted upon the riser, to multiple riser intervals above the soil where stake 52 is fully inserted and multiple risers 50 are mounted thereon and spotlight 10 is mounted upon the topmost riser 50. This adaptability allows spotlight 10 to be positioned in new landscaping and adjusted as the landscaping grows or repositioned depending on aesthetic considerations.

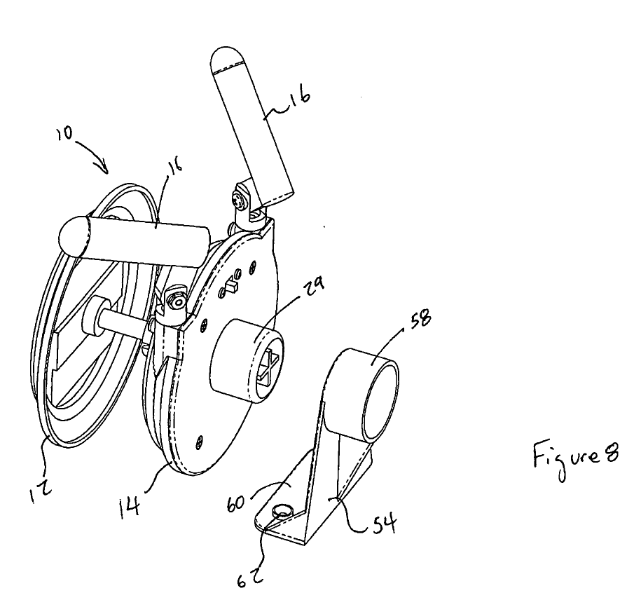

Referring now to FIG. 8 of the drawings, spotlight 10 is shown detached from surface mount 54. Surface mount 54 has a mounting portion 58 adapted for direct connection to support member of spotlight 10 or riser 50. Surface mount 54 also has a surface face 60 adapted for connection to a surface. In the embodiment shown, surface face 60 is flat with holes 62 for attachment via nails, screws and the like. Alternatively, surface face 60 may be profiled to match a particular surface shape, such as a round fence post, a square fence post, or the squared edge of a deck member. Additionally, holes 62 may be shaped to receive alternate attachment means, such as strapping, bands, or other like attachment means.

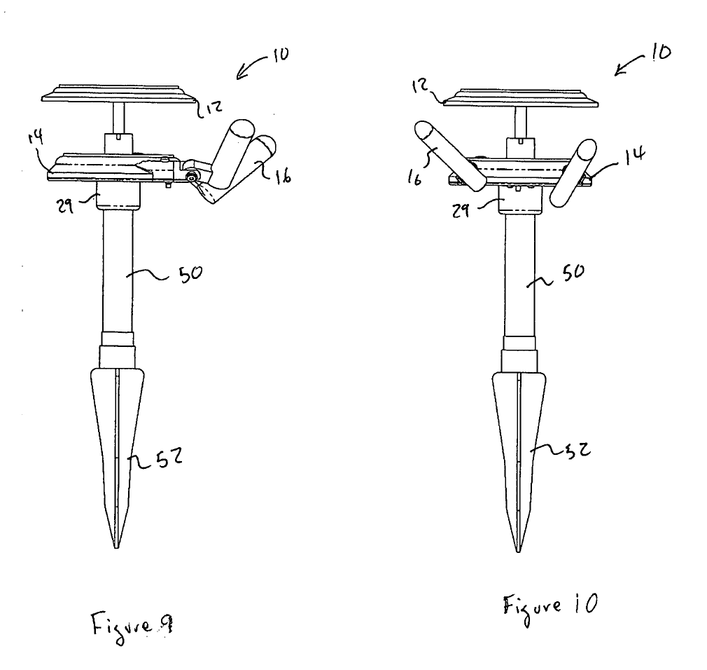

Referring now to FIGS. 9 and 10, spotlight 10 is shown mounted on riser 50 and stake 52 from a side view and a front view, respectively. Solar housing 12 is shown normal to upper surface 22 of main housing 14; however, it should be understood that ball 32 and cup 34 allow the repositioning of solar housing 12 relative to main housing 14 as discussed above.

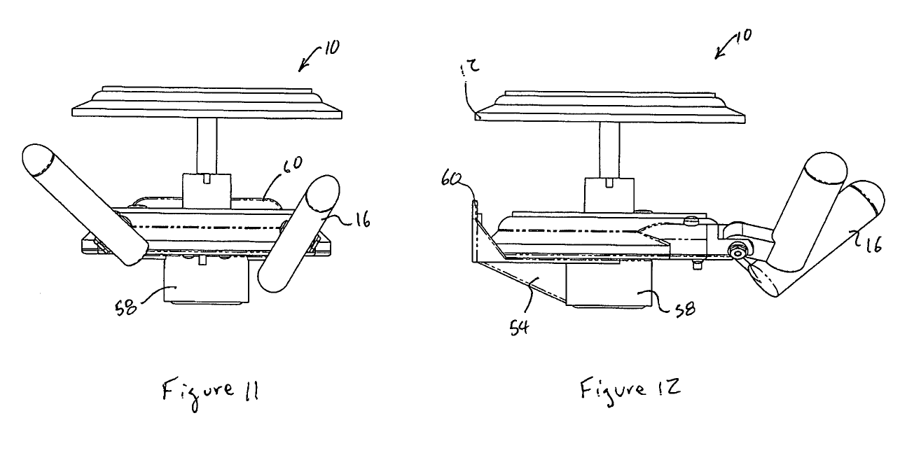

Referring now to FIGS. 11 and 12, spotlight 10 is shown mounted on surface mount 54 from a front view and a side view, respectively. Light housings 16 are shown in a similar position to other figures; however, it should be understood that support arm 38 may rotate in receptacle 42 and leg 36 may rotate about hinge screw 40 to provide a very wide range of motion for light housings 16.

It is apparent that an invention with significant advantages has been described and illustrated. Although the present invention is shown in a limited number of forms, it is not limited to just these forms, but is amenable to various changes and modifications without departing from the spirit thereof.

We claim:

1. A solar light, comprising:
a main housing;
two or more lighting elements coupled to the main housing, each lighting element being independently movable relative to the main housing; and
a solar energy collection system conductively coupled to the main housing.

2. The solar light according to claim 1, wherein the solar energy collection system is coupled to the main housing via a universal joint.

3. The solar light according to claim 1, wherein each lighting element is coupled to the main housing via a universal joint.

4. The solar light according to claim 1, further comprising:
a means for mounting the solar light in a selected position.

5. The solar light according to claim 4, wherein the means for mounting the solar light in a selected position is chosen from the group consisting of:
a stake;
an adjustable riser; and
a surface mounting bracket.

6. The solar light according to claim 4, wherein the means for mounting the solar light in a selected position is a telescoping adjustable riser.

7. The solar light according to claim 1, further comprising:
a rechargeable electrical power source conductively coupled to the lighting elements and the solar energy collection system.

8. The solar light according to claim 7, wherein the rechargeable electrical power system and at least part of the solar energy collection system are housed within a single housing separate from the main housing.

9. The solar light according to claim 7, wherein the rechargeable electrical power system is disposed within the main housing.

10. The solar light according to claim 7, wherein the rechargeable electrical power system is disposed within at least one of the lighting elements.

11. The solar light according to claim 7, wherein the rechargeable electrical power system is located remote from the solar light.

12. The solar light according to claim 1, further comprising:
at least one switch for controlling the operation of the solar light.

13. The solar light according to claim 1, further comprising:
at least one sensor for controlling the operation of the solar light.

14. The solar light according to claim 1, wherein each lighting element includes at least one light emitting diode.

15. The solar light according to claim 14, wherein at least one of the lighting elements is capable of producing at least two different colors of light.

16. A solar light, comprising:
a support structure;
a solar energy collection system conductively coupled to the support structure;
at least two light housings, each light housing being coupled to and independently movable relative to the support structure; and
a rechargeable electrical power source for providing electrical power to the solar light.

17. The solar light according to claim 16, wherein the rechargeable electrical power source is carried by the support structure.

18. The solar light according to claim 16, wherein the solar energy collection system and the rechargeable electrical power source are both carried by a universally adjustable housing.

19. The solar light according to claim 16, wherein the rechargeable electrical power source is carried by at least one of the light housings.

20. A methods of illuminating an outdoor area, comprising the steps of:
providing a solar light having a rechargeable electrical power source and at least two lighting fixtures;
adjusting one of the lighting fixtures in a first orientation for illuminating a first outdoor area; and
independently adjusting the other lighting fixtures in other orientations for illuminating other outdoor areas.

21. The method according to claim 20, further comprising the steps of:
providing multi-colored lights; and
illuminating the outdoor areas with the multi-colored lights.
